(19) United States
(12) Patent Application Publication
(10) Pub. No.: US 2007/0074880 A1
(43) Pub. Date: Apr. 5, 2007

(54) Carrier strip system and method for different diameter fasteners

(76) Inventor: Paul Gaudron, Stamford, CT (US)

Correspondence Address: CANTOR COLBURN, LLP, 55 GRIFFIN ROAD SOUTH, BLOOMFIELD, CT, 06002, US

(21) Appl. No.: 11/230,890

(22) Filed: Sep. 20, 2005

(51) Int. Cl. B25B 21/02

(52) U.S. Cl. 173/1

(57) ABSTRACT

A carrier strip system includes a plurality of discrete carrier strips respectively receptive of fasteners of substantially different dimensions. The strips have internal features that engage the fasteners. The strips further substantially identical external dimensions such that the external dimensions are engageable with a single setting tool magazine such that fasteners with differing dimensions have consistent alignment within a single setting tool magazine.

### BACKGROUND

Fastener setting tools have become common tools in the construction industry. Their ability to drive a fastener fully with just the pull of a trigger is significantly more efficient than methods of hammering or screwing fasteners in. Traditionally, setting tools required their fasteners be loaded one at a time into the proper position in the setting tool before they could be driven into the work piece. More recently, setting tools have included a magazine that spring loads several fasteners, for auto loading, which significantly increases the speed at which large numbers of fasteners can be driven. Such magazines are augmented with respect to function by the advent of fastener holders in the form of carrier strips.

A wide variety of fasteners are now available for use with setting tools. This variety is required to meet the particular demands of the work pieces being joined together. One common variation in fasteners is their diameter. Different diameter fasteners are employed in distinct magazines or distinct setting tools. Distinct magazines at best are required in order to ensure proper feed of the fasteners. Such arrangements require a user employing fasteners of different diameters to have multiple magazines or multiple setting tools, and further may require additional time when magazines are replaced to accommodate different diameter fasteners. This leads to inefficiency and is therefore undesirable.

### SUMMARY

Disclosed herein is a carrier strip system which includes a plurality of discrete carrier strips respectively receptive of fasteners of substantially different dimensions said strips having internal features and configured to complementarily engage said fasteners, said strips further having substantially identical external dimensions such that said plurality of discrete carrier strips are receivable into a single setting tool magazine.

Further disclosed herein is a method enabling receipt of different dimension fasteners in a single setting tool magazine constructing discrete carrier strips having substantially identical external dimensions and distinct internal dimensions complementary to respective fasteners having different dimensions; loading said fasteners having said substantially different dimensions into said respective carrier strips having said substantially identical external dimensions and distinct internal dimensions complimentary to said respective fasteners, said external dimensions facilitating receipt of said respective strips in a single setting tool magazine.

### BRIEF DESCRIPTION OF THE DRAWINGS

Referring now to the drawings wherein like elements are numbered alike in the several Figures:

FIG. 1 is a front elevation view of a large diameter carrier strip assembly of an embodiment of the invention;

FIG. 2 is a side elevation view of the carrier strip assembly of FIG. 1;

FIG. 3 is a front elevation view of a small diameter carrier strip assembly of an embodiment of the invention;

FIG. 4 is a side elevation view of the carrier strip assembly of FIG. 3.

### DETAILED DESCRIPTION

In connection with the above-identified drawbacks of the prior art, the presently disclosed concept allows for fasteners of different diameters to be run in the same magazine of a setting tool. In order for such an application to be possible, an outside diameter of a fastener carrier strip must remain the same for different fastener diameters and yet securely hold the fastener in place. Moreover, since setting tool magazines employ a diametric surface of the fastener as an additional guiding surface, where narrower diameter fasteners are to be utilized in the same setting tool magazine accommodation must be made for the guiding function of the outside diameter of the larger diameter fasteners when using the smaller diameter fasteners.

Referring to FIG. 1, a large diameter carrier strip assembly 1 is illustrated comprising: large diameter fastener(s) 2, a large diameter head-end break-free strip 4 made of several head-end segments 5, and a large diameter point-end break-free strip 6 made of several point-end segments 7. The carrier strip assembly 1 is illustrated in a condition in which it may be loaded into a fastener setting tool such as a combustion driven fastening system.

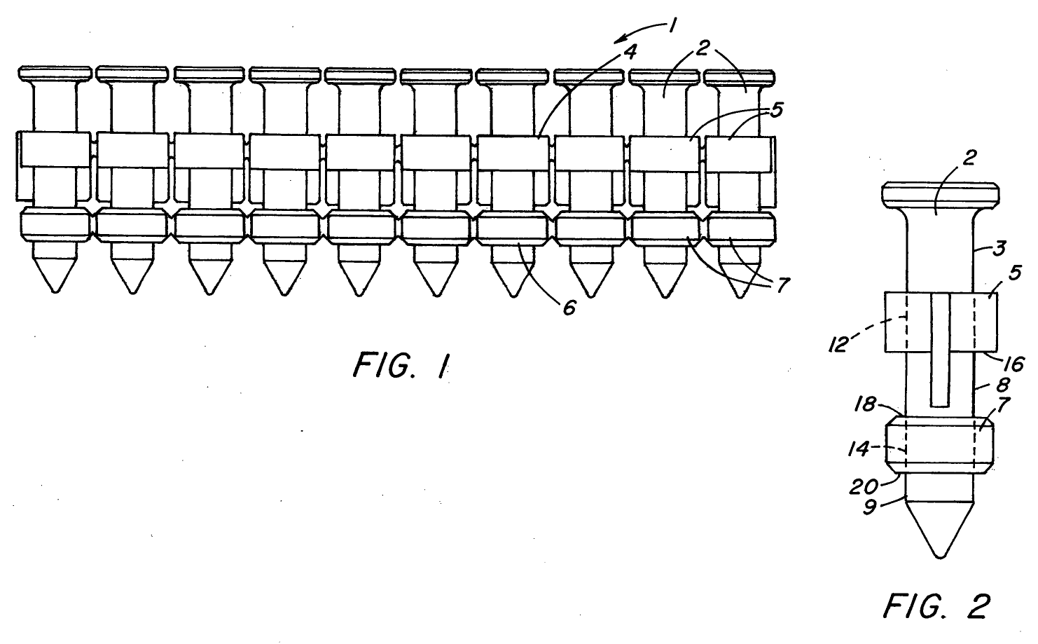

Referring now to FIG. 2, each head-end segment 5 has a hole 12 there through and each point-end segment 7 has a hole 14 there through. The segment 5 to segment 5 spacing in the head-end break-free strip 4 is equal to the segment 7 to segment 7 spacing of the point-end break-free strip 6, causing the hole 12 to hole 12 spacing to be the same as the hole 14 to hole 14 spacing. Holes 12 and 14 are sized to create an interference fit with the outside diameter 3 of the large diameter fastener 2. The interference fit maintains the relative position of the large diameter head-end break-free strip 4, the large diameter point-end break-free strip 6 and the large diameter fastener(s) 2 to each other.

As alluded to above there are several registers for the strip in a magazine (not shown), these are both diametrical and axial. These registers contact surfaces on the components that make up the large diameter carrier strip assembly 1 to assure the large diameter carrier strip assembly 1 will be properly guided and indexed within the magazine and setting tool (not shown). Diameters 8 and 9 are registered in the magazine to assure proper alignment of the fastener 2 prior to discharge from the fastener setting tool. Diameter 8 is immediately beyond radial surface 16 of head-end segment 5 in the direction of the point-end of the fastener 2, and diameter 9, is immediately beyond radial surface 20 of point-end segment 7 in the direction of the point-end of the fastener 2. Axial surfaces 18 and 20 are also registered in the magazine to properly locate the fastener 2 in an axial direction prior to its discharge from the fastener setting tool. Radial surface 18 is formed from the head-end of segment 7 and radial surface 20 is formed from the point-end of segment 7. Since surface 18 and surface 20 are formed on the same component, segment 7, the distance between them can be accurately controlled.

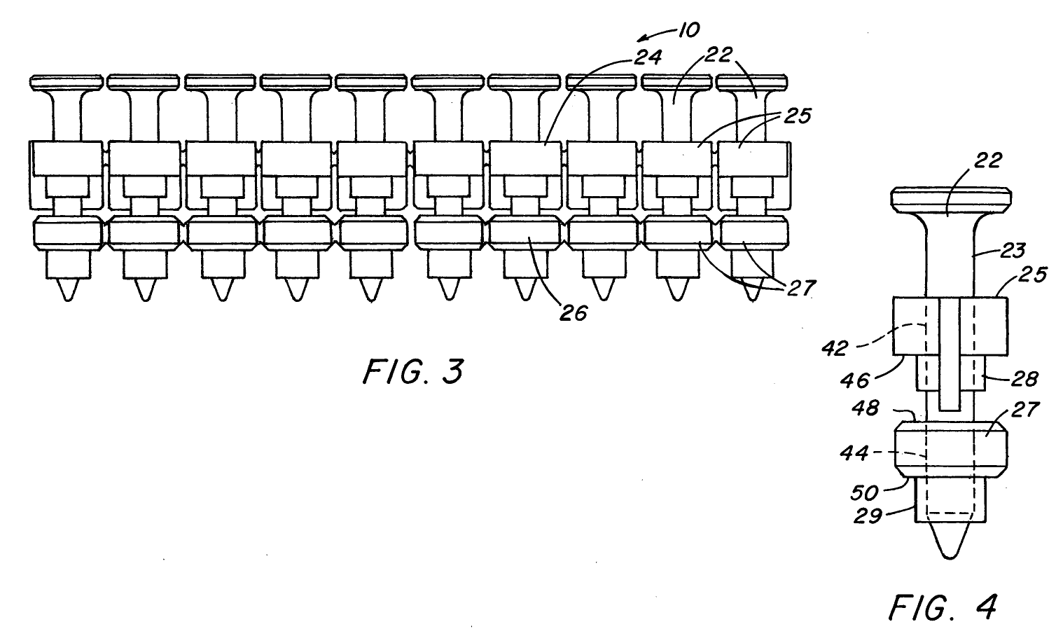

Referring to FIG. 3, a small diameter carrier strip assembly 10 is illustrated comprising: small diameter fastener(s) 22, a small diameter head-end break-free strip 24 made of several head-end segments 25, and a small diameter point-end break-free strip 26 made of several point-end segments 27. The carrier strip assembly 10 is illustrated in a condition in which it may be loaded into a fastener setting tool such as a combustion driven fastening setting tool.

Referring now to FIG. 4, each head-end segment 25 has a hole 42 there through and each point-end segment 27 has a hole 44 there through. The segment 25 to segment 25 spacing in the head-end break-free strip 24 is equal to the segment 27 to segment 27 spacing of the point-end break-free strip 26, causing the hole 42 to hole 42 spacing to be the same as the hole 44 to hole 44 spacing which also matches the hole 12 to hole 12 spacing of the large diameter head-end break-free strip 4. Holes 42 and 44 are sized to create an interference fit with the outside diameter 23 of the small diameter fastener 22. The interference fit maintains the relative position of the small diameter head-end break-free strip 24, the small diameter point-end break-free strip 26 and the small diameter fastener(s) 22 to each other.

As described earlier, there are several registers for guiding the large diameter carrier strip assembly 1 within the magazine of the fastener setting tool. The surfaces on the components of the small diameter carrier strip assembly 10 that interface with the registers in the magazine must therefore match those from the large diameter carrier strip assembly 1 in order for the small diameter carrier strip assembly 10 to feed properly into the magazine of the fastener setting tool.

Therefore, segments 27 that make up the small diameter point-end carrier strip 26 have surfaces to match those of the segments 7 of the large diameter point-end carrier strip 6. Specifically, the radial surfaces 48 and the radial surfaces 50 will register within the magazine just as the radial surfaces 18 and radial surfaces 20 did for the large diameter head-end segments 5. Further, the axial distance separating radial surfaces 48 from radial surfaces 50 of segments 27 match the axial distance separating radial surfaces 18 from radial surfaces 20 of segments 7. Thereby, allowing either the large diameter fastener carrier strip 1 or the small diameter fastener carrier strip 10 to axially register within a single magazine.

Similarly, the diametrically registering surfaces match as well. Specifically, diameters 28 of segments 25 match the diameters 8 of the large diameter fasteners shank 8. The fact that diameters 28 are formed as part of the segments 25 whereas diameters 8 are formed as part of the fasteners 2 will not effect the registration within the magazine as long as the diameters are equal.

The other diametrically registering surfaces from the large diameter carrier strip 1 are diameters 9 of the large diameter fasteners shank 8. Therefore, diameters 29 of segments 27 match that of diameters 9 of large diameter fasteners 2.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A carrier strip system comprising:
a plurality of discrete carrier strips respectively receptive of fasteners of substantially different dimensions said strips having internal features configured to engage said fasteners, said strips further having substantially identical external dimensions said external dimensions being engageable with a single setting tool magazine such that fasteners with different dimensions have consistent alignment within a single setting tool magazine.

2. The carrier strip system of claim 1, wherein:
the carrier strips are made of a head-end break-free strip and a point-end break-free strip.

3. The carrier strip system of claim 1, wherein:
the different dimensions of the fasteners are shaft diameters of the fasteners.

4. (canceled)

5. A method of presenting substantially differently dimensioned fasteners to a single setting tool through a single setting tool magazine, comprising:
sizing internal dimensions of a plurality of discrete carrier strips to engage substantially different dimensions of discrete fasteners;
loading said discrete fasteners into said plurality of discrete carrier strips; and
maintaining external dimensions of said plurality of discrete carrier strips such that said plurality of discrete carrier strips are engageable in a single setting tool magazine by at least the external dimensions to consistently align said discrete fasteners relative to a single setting tool magazine.
